(19) United States
(12) Patent Application Publication
(10) Pub. No.: US 2003/0222893 A1
(43) Pub. Date: Dec. 4, 2003

(54) Light emitting diode display and method for the illumination thereof

(75) Inventors: Robert D. Koester, Mogadore, OH (US); Robert A. Gebben, Canton, OH (US); Terry L. Yakupcak, Uniontown, OH (US)

Correspondence Address: Ray L. Weber, Renner, Kenner, Greive, Bobak, Taylor & Weber, Fourth Floor, First National Tower, Akron, OH, 44308-1456, US

(73) Assignee: Lockheed Martin Corporation

(21) Appl. No.: 10/158,321

(22) Filed: May 30, 2002

(51) Int. Cl. G09G 5/10

(52) U.S. Cl. 345/691

(57) ABSTRACT

A large visual display mountable on a support structure includes a plurality of pixel array panels configured in a M-row×N-column display. Each pixel array panel has a plurality of pixel boards configured in a R-row×S-column matrix carried by the support structure. A plurality of lighting elements are disposed on each pixel board. A control circuit is carried on at least one of the pixel boards in each plurality of pixel array panels. An interface system sends a data signal to each control circuit for illumination of the lighting elements. The interface system grabs an image made up of a plurality of pixels from a source and then loads the image into a buffer. The system then accesses the buffer line-by-line, and segments portions of each line for re-arrangement with other portions of lines into an order usable by the light emitting diode display.

### TECHNICAL FIELD

This invention relates to displays. In particular, the present invention relates to a large light emitting diode display mountable to a movable, flexible, and transportable support structure. Specifically, the present invention is directed to a system for converting an image, such as a video or a still photograph, for illumination by a light emitting diode display mounted on the support structure.

### BACKGROUND ART

It is known to provide large light emitting diode (LED) displays on structures such as airships or to provide projection screens at staged events such as concerts, sporting events, and the like. These types of displays are typically limited by their weight, their high maintenance costs, and the cost for transporting the displays from one place to another.

Where the large displays are to be used with lighter-than-air vehicles, such as airships, the weight of the display is critical. It will be appreciated that the size and picture element (pixel) density of the display significantly contributes to the airship load and, as such, the airship is only capable of lifting a predetermined size display.

Current designs for large displays utilized by airships require individual driving circuit boards for each pixel. Each pixel carries the appropriate number of LEDs and their respective driving electronics. Moreover, these displays require different types of driving circuit boards for day operation and night operation, and different types of boards depending on their position within the display. During the day, only orange LEDs are used, while at night, each board uses red, green, and blue LEDs to provide a full color image. Each pixel circuit board receives a data signal to select the intensity level for each LED as well as a power signal to illuminate each LED. Each pixel board is farther limited by its use of current summing circuitry that drives the diodes to the appropriate intensity. Moreover, because these pixel circuit boards are exposed to a harsh environment of wind, rain, and the like, their failure rate is quite high and the display is very expensive to maintain.

Due to the limitations of the current design, known displays are only capable of generating video at a maximum rate of 24 frames per second which appears quite animated and choppy. Moreover, due to their processing limitations, these displays are unable to reproduce live video. Any video-type image that is rendered by the display must be pre-programmed into the system. Yet another drawback of currently known large LED displays is that there is no redundancy provided in the distribution of power and/or data. Accordingly, if a data or power connection to one pixel circuit board is cut, it is quite likely that data signals to adjacent boards are affected.

Based upon the foregoing, it is evident that there is a need for a more reliable, lighter and more easily transportable LED display that has a higher pixel density and is capable of reproducing live video. Moreover, there is a need for such a display to be scalable so as to allow for even larger displays on structures which can support the weight of the associated boards and LEDs.

### DISCLOSURE OF INVENTION

It is thus a first aspect of the present invention to provide a light emitting diode display and method for the illumination thereof.

It is thus an aspect of the present invention to provide a display which is made up of any number of rows and columns, wherein the size of the display is only limited by the amount of power deliverable to the display, the speed at which the computer can process the acquired image into serial data, and the rate at which serial data can be transferred into the display.

It is another aspect of the present invention, as set forth above, to provide a display made up of pixel array panels, each of which preferably has the size of three LED pixel boards by three LED pixel boards. Each array panel is driven by a control circuit on the center board of the LED pixel boards containing the electronics to receive serial data and interface with an adjacent array panel, and wherein each control circuit on the center board generates the drive signals to illuminate LEDs on itself and the eight surrounding LED pixel boards, each of which only carries LEDs and series resistors. The three pixel by three pixel array panel may be treated as one replaceable assembly. Moreover, each LED pixel board may be replaced as needed.

It is yet another aspect of the present invention, as set forth above, to provide a display in which each LED pixel board within a pixel array panel carries a like number of red, green, blue, and orange light emitting diodes.

It is another aspect of the present invention, as set forth above, wherein the control circuit functions in either a Column Driver mode or an Array mode depending on the state of the serial data signal received.

It is still a further aspect of the present invention, as set forth above, that the control circuit staggers pulse-width-modulated drive signals included in the serial data which illuminate the LEDs in order to better equalize the amount of current required to drive the entire display.

It is yet a further aspect of the present invention, as set forth above, to provide a display wherein the brightness of each frame of video or image is normalized, if necessary, to limit the amount of current required to illuminate the display for high brightness images.

It is still yet another aspect of the present invention, as set forth above, to provide a computer interface system in which an original video or still image is re-sized to match the number of pixels provided by the display.

It is another aspect of the present invention, as set forth above, wherein the computer interface system converts each frame of video, after it has been normalized, to the serial data used to illuminate the display.

It is still a further aspect of the present invention, as set forth above, wherein the computer interface system provides a PCI hardware board, which plugs into a standard computer PCI card slot, that contains the hardware circuitry which generates the control signals, and converts the LED intensity data stored in sequential memory addresses to the serial data stream in the correct order to match the configuration of the display.

It is yet another aspect of the present invention, as set forth above, to configure the control circuit to receive the serial data stream and control signals so that the data is cascaded horizontally and vertically throughout the display. Once the serial data is shifted into the entire display, additional control signals generate a plurality of pulse-width-modulated drive signals to vary the light level emitted by the LEDs. It is another aspect of the invention to configure the computer system and associated electronics so that the light levels for each of the LEDs can be adjusted at a rate exceeding thirty frames per second, resulting in a display which is able to be used for displaying live video, still pictures, or computer generated graphics images.

The foregoing and other objects of the present invention, which shall become apparent as the detailed description proceeds, are achieved by a large visual display mountable on a support structure including a plurality of pixel array panels configured in a M-row×N-column display, each pixel array panel having a plurality of pixel boards configured in a R-row×S-column matrix carried by the support structure, a plurality of lighting elements on each pixel board.

Other aspects of the present invention are attained by a computerized method for displaying an image on a light emitting diode display, including grabbing an image made up of a plurality of pixels from a source, loading the image into a buffer memory area via one of the computers DMA channels, processing the data contained in the buffer so that the image is re-sized to match the configuration of the display, and normalized to adjust the brightness of the resulting image.

These and other objects of the present invention, as well as the advantages thereof over existing prior art forms, which will become apparent from the description to follow, are accomplished by the improvements hereinafter described and claimed.

### BRIEF DESCRIPTION OF THE DRAWINGS

For a complete understanding of the objects, techniques and structure of the invention, reference should be made to the following detailed description and accompanying drawings, wherein:

FIG. 1 is a schematic representation of a light emitting diode display and control system;

FIG. 2 is a schematic representation of the display employed in the present invention;

FIG. 3 is a schematic representation of a pixel array panel;

FIG. 4 is a block diagram of the PCI Control Board driver electronics; and

FIG. 5 is a flow chart illustrating the process steps for converting an image to a data signal receivable by the display;

FIG. 6 is a schematic diagram of a portion of the pixel array panel showing the horizontal and vertical shift registers;

FIG. 7 is a block diagram of the control circuit used in the array panel; and

FIG. 8 is a block diagram of a pixel drive control circuit utilized by the control circuit.

### BEST MODE FOR CARRYING OUT THE INVENTION

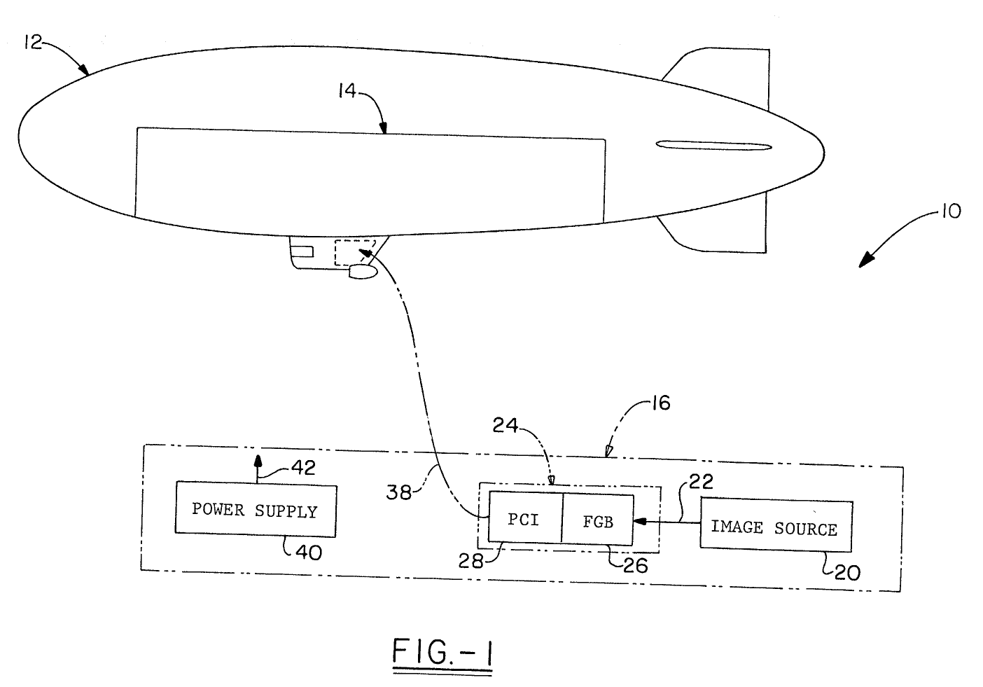

Referring now to the drawings and, in particular, to FIG. 1, it can be seen that a large light emitting diode (LED) display system is designated generally by the numeral 10. The system 10 may be utilized to present still images, animated images, or even video images at a rate of at least 30 frames per second. The system 10 includes a supporting structure 12, which in the preferred embodiment of the present invention is an airship, although the supporting structure 12 could be any other large structure, that is transportable from one place to another. It is envisioned that the structure 12 may be placed upon a heavy-duty fabric or the like that is foldable to allow for easy transportation of the system when not in use. As such, the structure 12 may be attached to buildings, bridges, and the like for use at concerts and sporting events. The system 10 includes a display 14, which is made up of multiple light emitting diodes and their respective driving circuits, that is carried by the supporting structure 12.

A control system 16 is associated with the display 14 and provides the necessary controls for illuminating the light emitting diodes on the display in a desired sequence. It will be appreciated that the entire control system 16 may be carried by the supporting structure 12. Or portions of the control system 16 may be situated at a remote location..

An image source 20 is included in the system 16 and may be an on-board camera carried by the airship looking down at a sporting event or the like and which can provide a live video feed. Alternatively, the image source 20 may be any form of media which can generate a video, still or animated image, such as video cassette recorder, a DVD player, an internet site, a satellite transmission signal, a radio frequency (RF) link or the like. It will also be appreciated that the image source 20 may be carried internally or it may be a stand-alone device that sends a signal to the control system. In any event, the image source 20 generates an image signal 22 that is received by a computer interface system 24. The interface system 24 is preferably personal computer with the necessary memory, hardware, and software for converting the image signal, such as a video signal, into a usable format, and generating the required control signals for rendering an image on the display 14.

The interface system 24 includes a frame grabber board (FGB) 26 that is in communication with a PCI board 28 operative with the processor of the personal computer. Generally, the PCI board 28 receives the image data 22, which has been processed by the personal computer, from the frame grabber board 26 for conversion to a stream of serial data 38 that is received and rendered by the display 14. Details of this conversion process will be discussed below. In addition to including image information the serial data 38 includes clock signals, control signals and the like for rendering an image. The control system 16 also includes a power supply 40 which may be carried by the support structure or in close association therewith. The power supply 40 generates a voltage carried by a power bus 42 used to illuminate the light emitting diodes and power the associated electronics as needed. In the preferred embodiment, it is envisioned that the power supply includes a 28 volt unregulated source to illuminate the LEDs and an unregulated eight-volt source to drive the control circuitry. Of course, these voltage values may change as dictated by the number of elements of the display. Those skilled in the art will appreciate that the total amount of current required to operate the system 10 is dependent upon the number of pixels provided by the display 14.

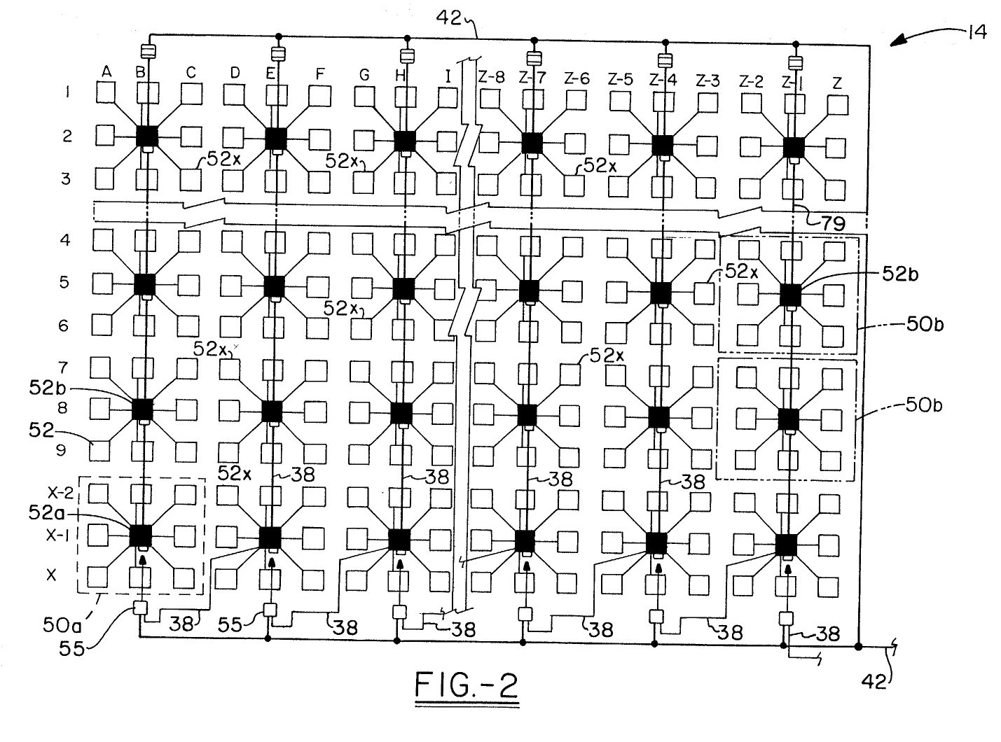

Referring now to FIG. 2, it can be seen that the display 14 includes any number of rows and columns of picture elements or pixels. The size of the display 14 may be referred to as M-rows by N-columns. The columns are alphabetically designated A, B, C, and so on, and the rows are numerically designated 1, 2, through (x−1), and (x). Accordingly, the upper left pixel is designated as A1 and the lower right pixel is designated as Z (x). The display may be sized 159×90, although other size displays could be constructed according to the teachings of the present invention.

The display 14 is made up of a plurality of pixel array panels designated generally by the numeral 50. The array panels 50 have alphabetic suffix designations (a, b) to indicate particular features that they possess. These suffix designations are based upon the array's position in the display and their role in transferring data to adjacent panel arrays. Briefly, the array panels 50a—also referred to as a Column Driver Mode Panel—are located on the bottom row of the display and they function to receive a portion of the serialized data 38 that represents a portion of the image to be displayed. Once the bottom array panels 50a are filled, the data temporarily stored therein is transferred to an array panel 50b—also referred to as an Array Mode Panel—in the same column immediately above each respective Column Driver Mode Panel 50a. And then the array panels 50a receive more serialized data that represent another portion of the image. All the data received is then transferred up each column, one array panel at a time. These receiving and transferring processes are repeated until all the data is loaded into every array panel whereupon the LEDs are illuminated.

It will be appreciated that any number of pixel array panels could be used, wherein the only limitation is necessitated by the amount of current available from the power supply 40 and the ability of the interface system 24 to process the serial data 38 into a useable format. Each pixel array panel 50a and 50b includes a plurality of pixel boards 52, wherein the size of each array panel is defined by a R-rows by S-columns matrix. In the preferred embodiment, the R×S matrix array panel 50 is in a 3×3 configuration.

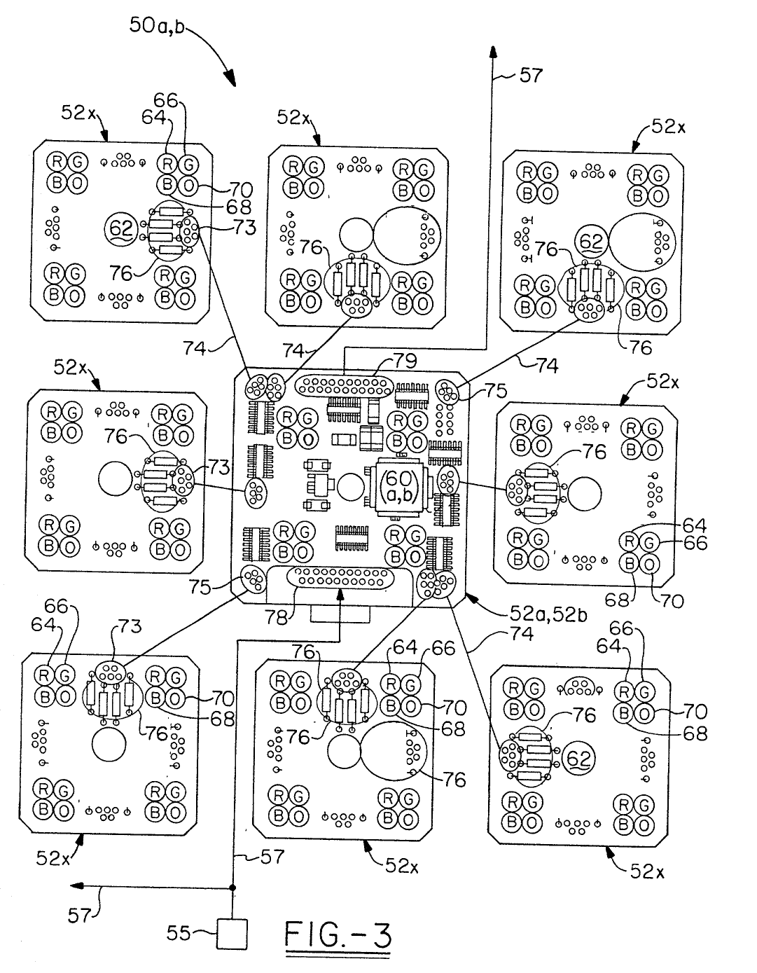

As can be seen in FIGS. 2 and 3, each pixel array panel 50 has nine LED boards 52. Each LED board 52 has an alphabetic designation (a, b, x) to indicate features that they possess. The most common LED board is designated as 52x which simply carries different color LEDs and corresponding current limiting resistors. There are typically eight LED boards 52x in each array panel 50a and 50b. The array panel 50a carries an LED board 52a and array panel 50b carries an LED board 52b. As will be described in detail, LED boards 52a and 52b—in addition to carrying the color LEDs in the same way as boards 52x—carry circuitry for receiving and transferring the serial data 38 and the power signal 42.

A connector 55 functions to sum the unregulated power signal 42 into the serial data signal 38 that is received by the first Column Driver Mode Panel 50a in location Z(x). As will be discussed in detail, the serial data signal 38 is routed to all the Column Driver Mode Panels via connectors 55 at the bottom of each column and then all the Array Mode Panels until the serial data and power is distributed to the appropriate location.

The LED boards 52a and 52b are preferably located in the center of their respective pixel array panel 50. The outlying or surrounding LED boards 52x are configured so that they can be easily replaced if damaged. Since eight out of nine LED boards in every array panel are nearly the same there is a significant cost and weight benefit to this approach. Moreover, the reliability of this approach is significantly better than previous approaches because the electronics required to generate the display image is drastically reduced. The mechanical reliability of interconnecting the array panels 50 together is also improved since only the center pixel (LED boards 52a, 52b) of every array panel has a board-mount connector 78 on it, and the eight surrounding LED boards 52x are hardwired to their respective board 52a and 52b. The connector 78 has an integral gasket which eliminates moisture penetration which also improves the long term reliability to withstand severe weather and wind environments.

As can best be seen in FIG. 3, each LED board 52 provides a mounting hole 62 which is attached by a fastener to the substrate or other supporting structure 12. Located in each corner of the pixel board 52 is a red LED 64, a green LED 66, a blue LED 68, and an orange LED 70. Each LED board 52a and 52b has a control circuit 60 which is designated as 60a, 60b depending on whether it is associated with the array panel 50a or 50b. The control circuit 60 provides serial shift registers and PWM counter circuitry to control illumination of the array panels 50a, 50b. Accordingly, by combining various intensity levels of the red, green, and blue LEDs, a wide range of color can be achieved. The red, green, and blue LEDs are primarily utilized for the display when it is used at night and the orange LEDs are primarily used in the daytime. It will be appreciated that the red, green, and blue LEDs can be simultaneously illuminated with the orange LEDs to provide additional brightness to the orange LEDs during daytime use.

Each LED board 52x is hardwired to the boards 52a, 52b. All LED boards 52 include current limiting resistors 76. It will be appreciated that there is one resistor 76 for each set of LEDs. One advantage of the invention is that the LED boards 52x carry no driving electronics. As such, if any LED or LED board 52x is rendered defective due to environmental or other matters, it can be replaced easily. Moreover, by limiting the control electronics to just the LED boards 52a, 52b, the weight and cost of the display is significantly reduced to allow for additional pixel density of the display 14.

Each LED board 52a, 52b includes the receiving connector 78 that receives the cascade control signals 57 which is then distributed to the other pixel array panels 50 by an output connector 79. As best seen in FIG. 2, the power signal is configured so as to enter the array panel columns from the top and the bottom, and the power signals are distributed using multiple wires. This approach allows for redundancy in the interconnection of the pixel array panels 50a, 50b and for the distribution of power in the event of a broken wire in the display.

The control circuit 60 monitors for a control signal that is either jumpered to ground or left floating. If jumpered to ground, the LED board 52 with the control circuit 60 functions as Column Driver Mode Panel 52a, and if not jumpered to ground the board 52 with the control circuit 60 functions as Array Mode Panel 52b. The ground jumper is implemented in the wiring of the connector 55. The Array Mode Panel 52b utilizes the control circuit 60b to transfer selected data up its respective column until all the arrays are loaded with data. Each control circuit 60a and 60b includes a Field Programmable Gate Array which contains Pulse Width Modulator circuitry to illuminate the LEDs as needed.

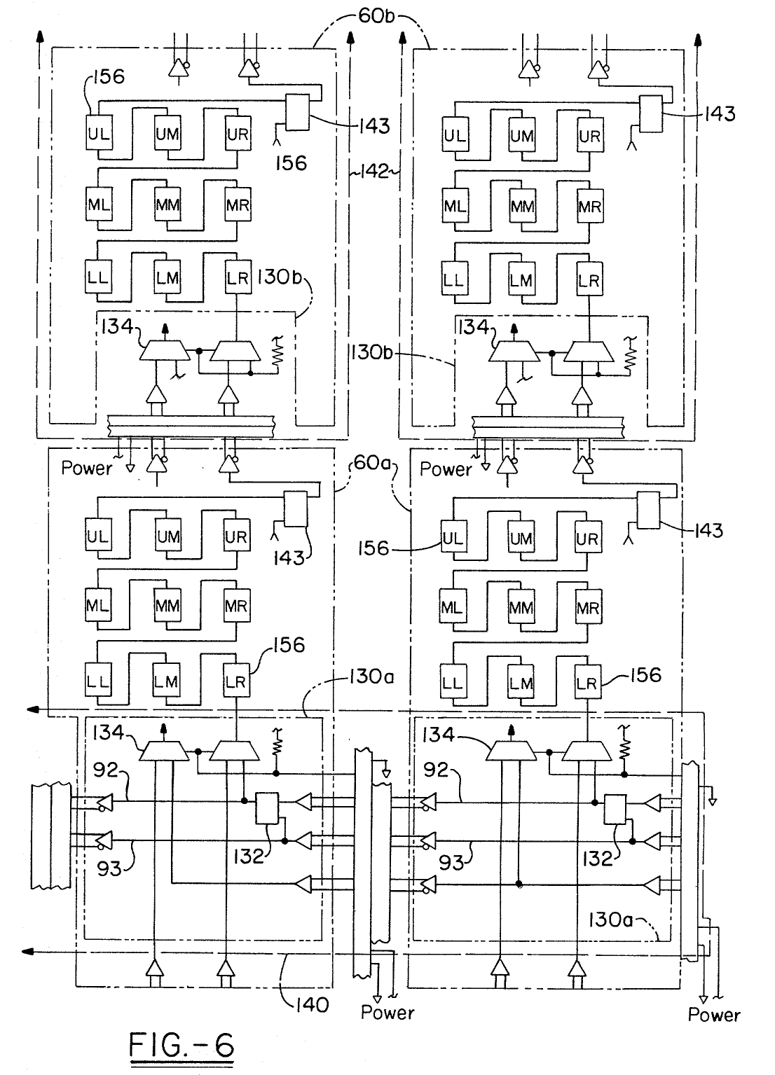

The Column Drive Mode Panels 52a are located in the bottom row of the array panels of each respective column and a control signal is jumpered to ground in the wiring harness which causes the control circuit 60a to function in a “column driver mode.” Accordingly, when the serial data signal 38 is first received by the display 14, it is serially shifted through all of the column driver boards 52a for distribution of the data signal by the control circuits 60. The control circuits 60a, 60b control the intensity of the light emitting diodes and cascade the power input, and control signals via differential line drivers and receivers—as will be shown in FIGS. 6-8—to the adjacent control circuits either horizontally, when configured in the “Column Driver” mode (the bottom row of array panels), or vertically when configured in the “Array Mode” (all other array panels). The circuits 60 provide signals to a set of high current drivers that drive the LEDs on the board 52a or 52b and the surrounding eight pixel boards 52x.

### DIGITAL IMAGE PROCESSING

Referring now to FIGS. 1, and 4-8, the process for converting an image signal 22 into the serial data 38, which is usable by the display 14, will now be discussed. As noted, the interface system 24 includes a personal computer that contains a commercially available video frame grabber board 26 such as an EPIX PIXCI-SV4. Of course, other similar frame grabber boards could be used. In order to display a video-type signal, the interface system 24 utilizes a software program that transfers the acquired video data from the frame grabber board 26 into the PCI board 28. Generally, the software of the system 24 processes the image from the image source 20 into a format that matches the number of horizontal and vertical pixels of the display.

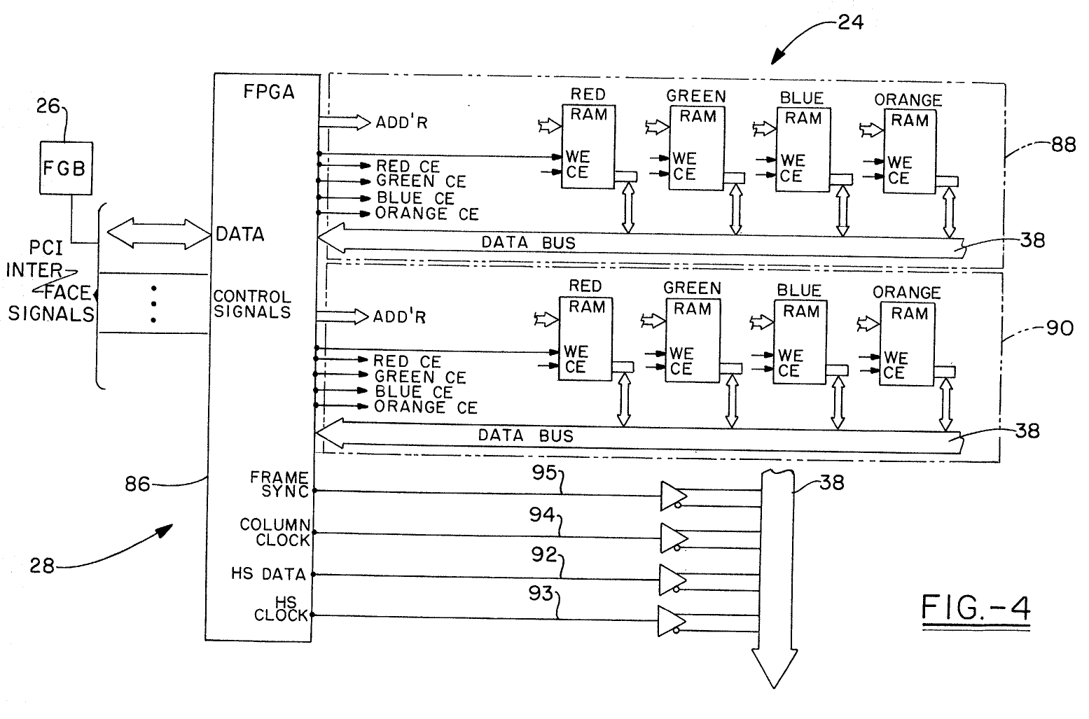

An acquired digital image is transferred into RAM of the personal computer 24 from the board 26. As seen in FIG. 4, the data contained in the RAM is processed by the interface system 24 and is then transferred to the PCI board 28, which includes a Field Programmable Gate Array (FPGA) 86 that generates the serial data signal 38 with the necessary control signals to interface with the display 14. The serial data signal 38 includes, but is not limited to, a high speed data signal 92, a high speed clock signal 93, a column clock signal 94 and a frame synchronization signal 95. The PCI board 28 includes “Ping-Pong” static RAM buffers 88 and 90 which allow the interface system 24 to load the video image data into one buffer 88 at the same time as the FPGA hardware is generating the serial data signal 38 to transfer the serial data contained in the other RAM buffer 90 to the display 14.

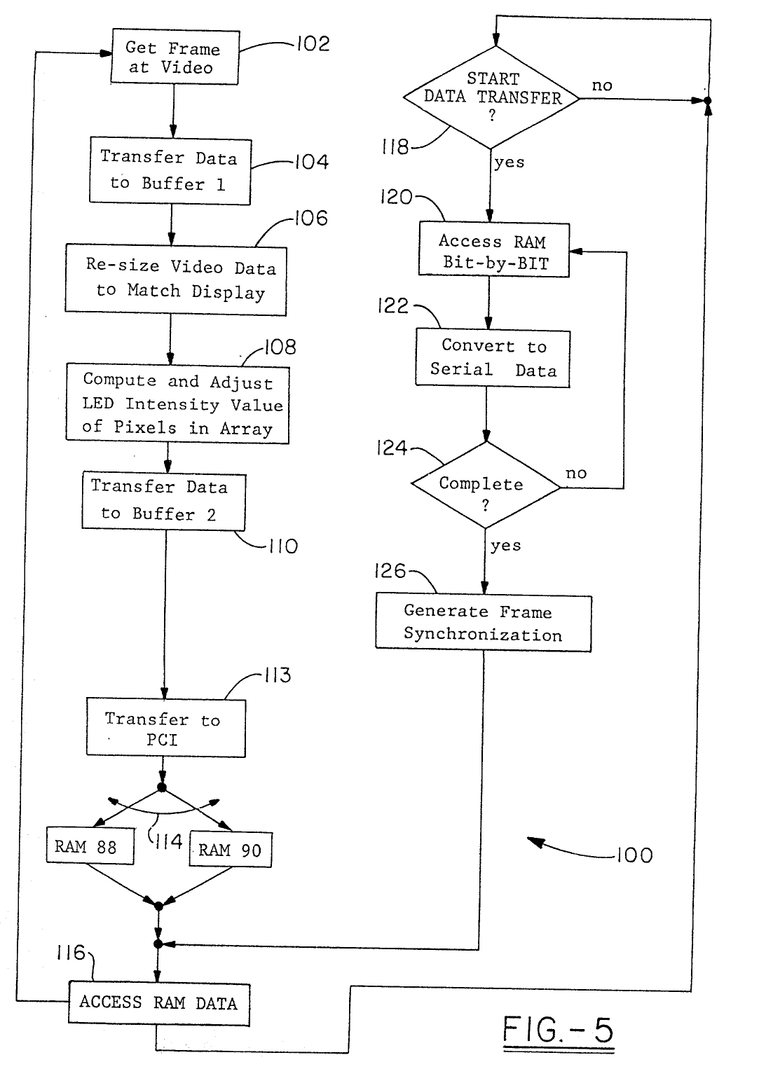

Referring to FIG. 5, the process steps are generally indicated by the numeral 100. As a first step 102, the process obtains a frame of video from the frame grabber board 26. It will be appreciated that the interface system 24 is running a computer program written in “C” in order to process the data going to the display on a frame-by-frame basis. The system 24 first monitors the frame grabber board 26 to determine when a frame of video is available in the frame grabber board's internal memory. The board 26 includes software driver utilities, which are used to perform common functions such as transferring data stored in memory. When a frame of video is available, the software initiates a Direct Memory Access (DMA) operation in order to transfer the data in the frame grabber memory into a first buffer area in the internal memory of the interface system 24 at step 104. Subsequently, at step 106, the software routine functions to decimate the data contained in the first buffer area by throwing away unneeded pixel information that makes up the frame of the video to make the aspect ratio of the image in the first buffer area match the M×N configuration of the display 14. Since the display 14 has a finite amount of current available to illuminate the light emitting diodes, the software, at step 108, computes and adjusts a running sum of all the intensity values for all the pixels in the array for the particular frame of video to be displayed. The software compares this value to a limit, based upon the current available to light the display 14 and the total number of pixels in the display, and normalizes or adjusts a pulse width modulation count, if necessary, for each pixel to effectively reduce the brightness of the display for a bright scene to correspond to the amount of current available.

When the conversion and normalization process is complete, the data is written into a second buffer area in the interface system 24 at step 110 in preparation for transferring the data to the PCI Display Driver board. As seen in FIG. 4, digitized data, which is obtained from the frame grabber board, contains eight-bit intensity values for red, green, and blue intensity for each pixel. The software routine adds another eight-bit value for the orange pixel and thereby creates a thirty-two bit word which is written into the second buffer area, so that the format of the data matches the configuration of the “Ping-Pong” buffer memory 88 and 90 on the PCI Display Driver board 28. As will be appreciated by those skilled in the art, the hardware on the PCI Driver board is designed so that its eight least-significant address lines are reserved for defining the horizontal address of each pixel, while the eight most-significant address lines define the vertical address of the pixel. For example, an address of all zeroes corresponds to the top-left most pixel. As such, if the configuration of the display is less than 256 pixels wide for any row, data written to memory locations with the upper addresses of the eight-bit horizontal address larger than the size defined by the PCI horizontal size register will be ignored. The pixel intensity information, the thirty-two bit word, is therefore stored in a rectangular fashion at a horizontal and vertical address in a format much like A1, A2, . . . Zx of the display 14 and which matches the hardware counter circuitry within the PCI Board Field Programmable Gate Array (FPGA) 86. The process of accessing the memory in the correct sequence will be described further.

Once the data has been transferred into the second buffer area so that it matches the configuration of the ping pong memory on the PCI board, the interface system 24 initiates the transfer to the PCI board 28 at step 113 using one of the computer's DMA Channels. At step 114, the interface system 24 selects which RAM, 88 or 90, is to be loaded. The interface system 24 makes this determination based upon which RAM is currently sending a frame of video to the display. The software routine monitors a status signal from the PCI board to determine if the hardware transfer of the previous video frame from the other RAM of the “Ping-Pong” buffer is complete. If it is, the software routine writes to a control register on the PCI board which switches RAM on the “Ping-Pong” buffer memory, allowing the hardware, at step 116, to access the RAM memory which was just loaded. The software routine then sends another control signal at step 118, which triggers the PCI hardware board to start sending the serial data 38 to the display 14.

In order to generate a video image at about 30 frames per second, the interface system 24 immediately starts processing another frame of data from the frame grabber board 26 by returning to step 102 from step 116 while the hardware on the PCI board is transferring the data to the display at steps 118-126. Steps 102-116 are continually repeated by the interface system to produce each frame of the video image.

### PCI Driver Board Control Signal Generation

As revealed in steps 118-126, the PCI board effectively converts the thirty-two bit pixel intensities stored in RAM 88 and 90 that correspond to a frame of video to a serial bit stream which matches how the array panels 50a and 50b are configured on the display. The individual bits of the red, green, blue, and orange intensity data are accessed in a somewhat scattered sequence due to the way that the array panels are connected and because each array panel 50a and 50b controls a three-by-three section of pixels. This conversion effectively transforms rectangular digital image information from the image source 20 into a serial bit stream that is compatible with the display 14. In other words, a line-by-line process would normally submit the data signal to a video source or display in a sequence of: line 1, columns A-Z; line 2, columns A-Z; line 3, columns A-Z, and so on. Such transmission of the data is unacceptable to the pixel array panels because of the way the serial shift registers within the control circuit 60 are configured to cascade the LED intensity data through each of the array panels 50. Accordingly, the interface system 24 generates the serial data stream and associated control signals in a sequence to drive any configuration of the display.

In order to accomplish the foregoing, the PCI board utilizes the RAM 88 and 90, the FPGA 86 which includes two control registers that are loaded to control the number of horizontal and vertical pixels in the array, and a control register to control the hardware operation of the PCI board. The FPGA 86 generates the control signals 92-95 to interface with the first column control circuit 60a that receives the data signal. Accordingly, at step 118, the interface system 24 initiates the serial data transfer. As noted previously, the PCI board 28 includes the two banks of static RAM 88, 90 which are configured as a “Ping-Pong” buffer so that as the computer is loading one buffer 88, the other buffer 90 is accessed by the hardware circuitry of the FPGA 86 which selects the individual bits of memory, at step 120, in the correct sequence to format the serial data for delivery to the display 14. Counter and data selector circuitry are implemented in the FPGA 86 to access the RAM 88, 90 to generate the serial bit stream, at step 122, in order to match the way that the serial shift registers included in the control circuit 60 are cascaded in the display.

The creation of the serial bit stream and control signals for steps 120 and 122 will be described only for the preferred implementation of the array panel, however other sequences could be generated for other configurations of array panels, other daisy-chain connections of the internal shift registers, or other number of data bits as well. By referring to FIG. 2 and FIG. 6, one can see how the array panels are interconnected, and how the shift-registers within each array panel are daisy-chained. FIG. 6 shows a portion of the overall array configuration and in particular the control circuits 60a, 60b associated with a pair of column driver mode panels and immediately adjacent array mode panels. Contained within each control circuit 60a, b is a data cascade circuit 130a, 130b, respectively. The data cascade 130a includes a flip-flop 132 to shift the incoming serial data 38 horizontally. The data cascades 130a and 130b both contain multiplexers 134 that assist in transferring the serial data signal through the array. For the data cascade 130a, the multiplexer 134 functions to transfer data from the flip-flop 132 horizontally, while the multiplexers 134 in the data cascade 130b function to transfer the serial data 38 vertically. Collectively, all the data cascades 130a form a horizontal shift register 140. And all the data cascade circuits 130b in a column collectively form a vertical shift register 142. The serial data 38 is transferred vertically between control circuits 60 via a flip-flop 143 which is effectively part of the data cascade 130. The output of the flip-flop 132 is connected to the input of a corresponding flip-flop in the adjacent column driver mode panel. The output of each flip-flop 132 also provides an input signal to a plurality of nine pixel drive controls 156 used to transfer intensity data for each array panel vertically. Each pixel drive control 156 is designated by a combination of letter designations, wherein the first letter—L, M, or U—designates lower, middle or upper, and the second letter—R, M, L—designates right, middle or left. The last bit in the chain of shift registers 156 cascade to the input of the next array panel vertically in each column. Each array panel is likewise connected to the next array panel all the way up each column.

FPGA 86 on the PCI board is designed to access the individual bits of intensity data which are stored in the rectangular “Ping-Pong” buffers 88 and 90 in the correct sequence to match the way that the array panels are cascaded. The approach used to load the display is to access the rectangular memory so that one bit of data signal 92, is loaded into each “Column Driver” array panel via a high speed clock signal 93, across the bottom of the array. Once every “Column Driver” array panel 50a contains one bit of data, the control circuitry generates the relatively slower Column Clock signal 94 to simultaneously shift the data into the vertical shift register 142 and the set of pixel drive controls 156. The sequence of sending one bit of data for each “Column Driver” horizontally at a high-speed rate, followed by a slower “Column Clock” to shift the data simultaneously through all the array panels 50, continues cascading the data horizontally and vertically through the display. When all of the required clock signals have been generated to load all the intensity data into all the array panels, each of the pixel drive controls 156 contain five bits of intensity data to control the Pulse-width-modulated drive signals for each of the red (bits 14 through 10), green (bits 9 through 5), and blue (bits 4 through 0) LEDs, and one bit for the orange LED (bit 15) (Note: the orange LED is only used for the Day mode operation of the display and is not Pulse-width modulated, it is either On or Off only). As can be seen in FIG. 6, for each of the pixel drive controls 156—each of which contains a shift register—the most significant bit of the lower-right shift register is cascaded to the lower-middle, the lower-middle is cascaded to the lower-left, the lower-left is cascaded to the middle-right, the middle-right is cascaded to the middle-middle, the middle-middle is cascaded to the middle-left, the middle-left is cascaded to the upper-right, the upper-right is cascaded to the upper-middle, and the upper-middle is cascaded to the upper-left. The most significant bit of the upper-left pixel becomes the data output of this array panel to the adjacent array panel up each three pixel wide column.

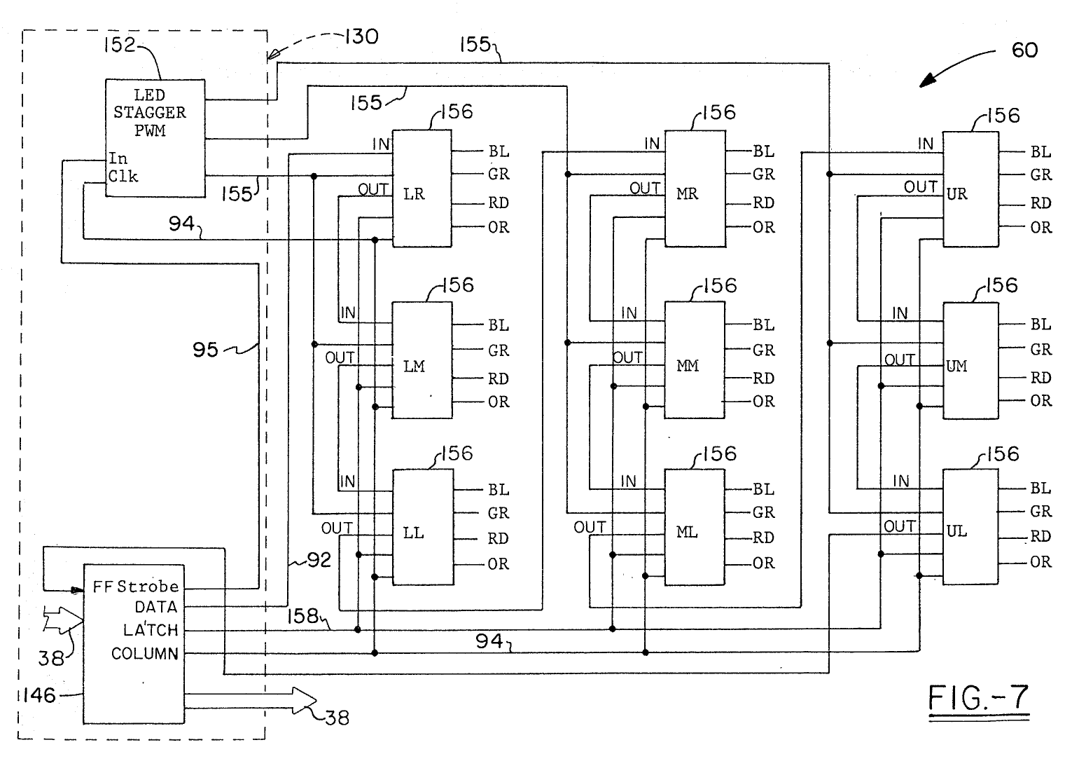

The sequence that the data and control signals are sent to the display is shown in FIG. 7. In addition to the flip-flops 132, 143 and the multiplexers 134, the data cascade 130 includes a data circuit 146, and an LED stagger pulse width modulator (PWM) 152. The serial data 38 is received by the data circuit 146 which distributes portions of the image information as needed. The data circuit distributes the frame synchronization signal 95 and the clock signal 94 to the LED stagger PWM 152, which in turn generates a set of three stagger signals 155 which are distributed to the lower, middle and upper pixel drive controls. This is done for the purpose of equally distributing the current so as not to overload the power supply. The data circuit 146 also distributes the column clock signal 94, the data signal 92 and a latch signal 158 in an appropriate sequence to all the pixel drive controls 156.

In operation, the control circuit 60a, 60b accesses the rectangular “Ping-Pong” buffer memory in such a way so that the most-significant bit of the last flip-flop 132 of the horizontal shift register 140 (Upper-left Orange bit of the three-by-three pixel in the top row of the display) in each column is read and shifted at a high speed rate into all the “Column Driver” array panels with the high-speed clock signal 93. This most-significant bit is the Orange pixel for the top line of the display columns A, D, G . . . (Z−2), where Z is the maximum horizontal dimension of the display. When all the “Column Driver” array panels have been loaded at a high speed rate, the Column Clock signal 94 shifts all these bits in parallel into the vertical shift register 142. Next, the control hardware accesses the next bit to be loaded into the next bit of the shift register in each shift register chain (which is the most significant bit of the red PWM intensity value of the upper-left pixel of every array panel in the top row of the display i.e. columns A, D, G . . . (Z−2)). This accessing process continues until the last bit of each sixteen bit shift register (Blue least significant bit—bit zero) is loaded into columns A, D, G . . . (Z−2)). Next a counter in the PCI driver board 28 is incremented which causes the hardware addressing circuitry to select the top middle pixel of the three-by-three array panel, of the top row while accessing the data pertaining to all the colors of the LEDs. (Columns B, E, H . . . (Z−1), to match the order that the shift registers in each array panel are cascaded. Next the counter is incremented to select the upper-right data for all the LED colors. (Columns C, F, I . . . (Z)) This completes loading intensity data into the top row of the display. Next another vertical address counter within the PCI control circuitry is incremented to access the next row of the intensity data and the process of accessing the data is repeated in columns (A, D, G . . . (Z−2)), columns (B, E, H . . . (Z−1), and columns (C, F, I . . . (Z)). As noted previously at step 124, the preceding process continues until the vertical address counter is equal to the vertical dimension of the array and the horizontal address has been incremented so that it points to the maximum horizontal dimension of the display. At this point the hardware circuitry has completed loading the entire shift register chain for the entire display.

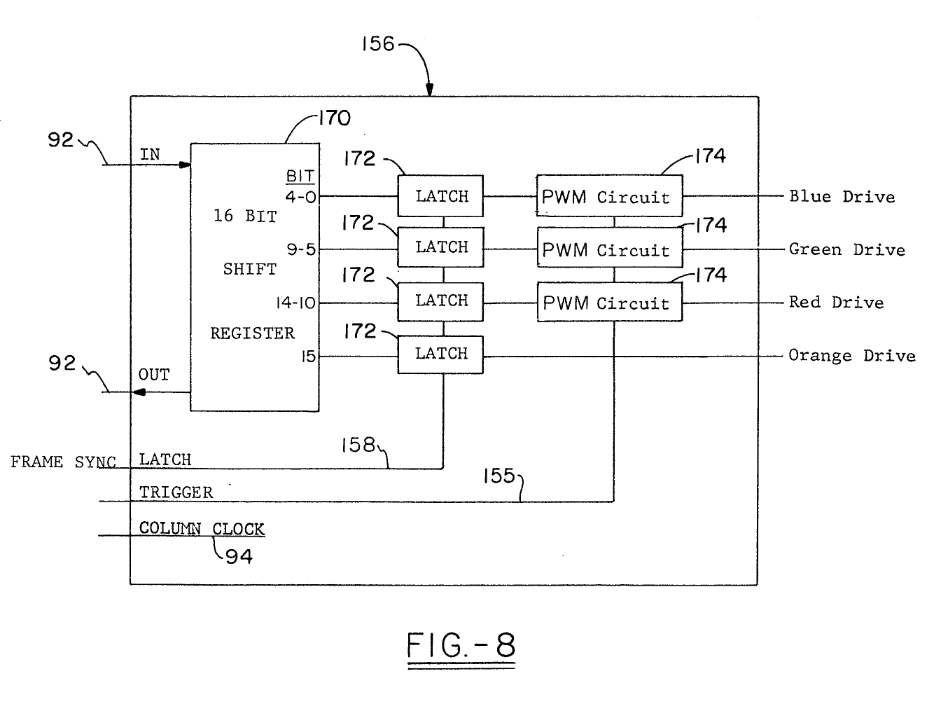

Referring now to FIG. 8 a detailed diagram of a pixel drive control is designated generally by the numeral 156. Each pixel drive control 156 includes a 16 bit shift register 170, a series of latches 172, and a series of PWM circuits 174. As can be seen, one latch 172 and one PWM circuit 174 is associated with each of the blue, red and green LEDs. Only a latch 172 is associated with the orange LED. When the data for the entire display has been loaded, the PCI hardware circuitry generates a frame synchronization signal 95, at step 126, which causes the serial data contained in the array panels to be latched into a latch circuit 172 within the FPGA in control circuit 60 which provides the appropriate count to the respective pulse-width-modulator counter circuits 174, except for orange, which is either on or off. The frame sync signal 95 also synchronizes a PWM stagger circuit 152 within each data cascade 130 which generates the stagger trigger signals 155 that trigger the PWM Counter circuits 174. Each array panel uses this stagger PWM 152 to derive its own staggered set of trigger signals 155 to better equalize the current required to drive the display. The “Column Clock” signal 94, which is used to shift the data vertically through all of the columns, also doubles as the source of the clock required by the PWM counter circuitry. The FPGA 86 on the PCI board 28 generates the column clock signal as a free-running signal which is synchronized, so that it occurs at the point in time when all of the “Column Driver” boards have been loaded with the high-speed data. This approach allows Pulse-width-modulated drive signals for the LED's to be generated continuously, at the same time as the data for the next frame is being loaded.

The array panels are designed so that the resulting display is modular so that any array panel may be interchanged easily to allow for routine maintenance of the display. The center pixel or LED board 52a, 52b also contains a linear regulator to derive a regulated Vcc Power for the circuitry on the boards. Therefore, each array panel can tolerate large variations in the unregulated power supply inputs to each module due to line drops in the wiring which connect the entire display together. The use of differential line drivers and receivers reduces susceptibility to noise either generated directly by the display or from external sources. Since the power and ground connections are cascaded between adjacent array panels across the display, and since each array panel is only connected to the preceding one in the chain, and the following one, noise induced by switching LED currents does not influence the signals from the line receivers because the common-mode rejection of the differential receivers causes the noise induced between adjacent boards to be rejected. The high-speed data transfer horizontally, and the slower data rate vertically through the array panels also results in the majority of the circuitry in the display using a slower data rate, resulting in improved reliability, and noise reduction in the design.

Based upon the foregoing, the advantages of the present invention are readily apparent. Primarily, the selective use of electronics allows for the elimination of electronics specific to each pixel to illuminate the pixels by using just one electronics board for a 3×3 pixel array. This significantly reduces the weight and the cost of maintaining a large area display. This significantly improves the pixel density and this allows for implementation of the pixel array panels on a flexible substrate that can be easily transported from venue to venue.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A large visual display mountable on a support structure comprising:
a plurality of pixel array panels configured in a M-row×N-column display, each said pixel array panel having a plurality of pixel boards configured in a R-row×S-column matrix carried by the support structure;
a plurality of lighting elements on each said pixel board;
a control circuit on at least one of said pixel boards in each said plurality of pixel array panels; and
an interface system for sending a data signal to each said control circuit for illumination of said plurality of lighting elements in said pixel array.

2. The display according to claim 1, wherein said control circuit receives said data signal and distributes a pulse-width modulated signal to said plurality of lighting elements for illumination thereof.

3. The display according to claim 1, wherein all of said control circuits in one of said M-rows are configured in a driver mode to initially receive said data signal, said driver mode distributing said data signal to respective control circuits in said N-column.

4. The display according to claim 3, wherein said control circuit receives said data signal and distributes a pulse-width modulated signal to said plurality of lighting elements for illumination thereof.

5. The display according to claim 3, further comprising:
a video source generating a video signal received by said interface system, said interface system converting said video signal to a serial bit stream for sequential loading into said plurality of pixel array panels.

6. The display according to claim 1, wherein said plurality of lights on each said pixel board includes at least one orange light emitting diode.

7. The display according to claim 1, wherein said plurality of lights on each said pixel board includes at least one red light emitting diode, at least one green light emitting diode, and at least one blue light emitting diode.

8. The display according to claim 1, wherein each of said pixel boards has a mounting hole for receiving a fastener to attach each said pixel board to the support structure so that said plurality of pixel array panels are transportable.

9. The display according to claim 1, further comprising:
a power supply for generating a power signal on a power bus, said power bus supplying current to said pixel boards and said control circuits.

10. A computerized method for displaying an image on a light emitting diode display, comprising:
grabbing an image made up of a plurality of pixels from a source;
loading said image into a buffer;
accessing said buffer line-by-line; and
segmenting portions of each line for re-arrangement with other portions of lines into an order usable by the light emitting diode display.

11. The method according to claim 10, further comprising:
re-sizing the image to match a M-row×N-column size of the light emitting diode display.

12. The method according to claim 10, further comprising:
computing a brightness intensity value for the image; and
normalizing the brightness intensity value for the light emitting diode display.

13. The method according to claim 10, wherein the light emitting diode display includes a plurality of pixel array panels configured in a M-row×N-column display having a plurality of pixel boards configured in a R-row×S-column matrix, the method further comprising:
segmenting each line into data bits corresponding to a width of each S-column; and
assembling said data bits so that said width of each S-column in said matrices are concatenated to one another.

14. The method according to claim 13, wherein each matrix includes only one control circuit, the method further comprising:
receiving said data bits in one of said control circuits in one of said M-rows; and
distributing said data bits from said control circuits to corresponding control circuits in respective N-columns.

15. The method according to claim 14, further comprising:
sending a synchronization signal to all of said column/logic circuits to latch said data bits; and
illuminating the light emitting diode display according to said data bits latched in said column/logic circuits.

16. The method according to claim 14, wherein said assembling step comprises:
loading said data bits into a first buffer until said image is fully loaded;
transferring said data bits in said first buffer to said control circuits; and
loading a next set of data bits into a second buffer simultaneously with said transferring step.

17. The method according to claim 16, further comprising:
transferring said data bits in said second buffer to said column/logic circuits while loading new data bits into said first buffer.

18. The method according to claim 13, wherein each said pixel board has a plurality of light emitting diodes, the method further comprising:
generating a pulse width modulation signal in each said control circuit for each said pixel board to illuminate said light emitting diodes to a desired intensity.

19. The method according to claim 10, wherein said image is a video signal.
